(19) United States
(12) Patent Application Publication
(10) Pub. No.: US 2026/0118650 A1
(43) Pub. Date: Apr. 30, 2026

(54) CATADIOPTRIC OBJECTIVE LENS

(71) Applicant: KYOCERA SOC Corporation, Yokohama (JP)

(72) Inventor: Takeshi YAMANAKA, Tokyo (JP)

(21) Appl. No.: 19/050,658

(22) Filed: Feb. 11, 2025

(30) Foreign Application Priority Data
Oct. 28, 2024 (JP) 2024-189316

(51) Int. Cl. G02B 17/08; G02B 21/04

(52) U.S. Cl. CPC G02B 17/0808; G02B 17/086; G02B 17/0892; G02B 21/04

(57) ABSTRACT

A catadioptric objective lens includes, in order from an infinite conjugate side: a first group composed of at least one refractive optical element; a second group composed of multiple optical elements including two reflective surfaces; and a third group composed of at least one optical element, wherein the catadioptric objective lens has an intermediate image point inside an optical system and satisfies a below conditional expression:

$$\frac{f 1}{f 3} < 0$$

where f1 is a focal length of the first group and f3 is a focal length of the third group.

### CROSS-REFERENCE TO RELATED APPLICATIONS

The present application is based upon and claims the right of priority to Japanese Patent Application No. 2024-189316, filed Oct. 28, 2024, the disclosure of which is hereby incorporated by reference herein in its entirety for all purposes.

### TECHNICAL FIELD

The present invention relates to a catadioptric objective lens, and particularly relates to a catadioptric objective lens suitable for use in microscopic observation/inspection over a broad spectral range.

### BACKGROUND ART

Optical microscopic inspection devices are utilized to various applications in wide technical fields including material, semiconductor, and biomedicine.

In some of applications, such inspection devices comprise multiple illumination methods to conduct complex observations (inspections). For example, there is known an inspection device that combines brightfield observation using coaxial epi-illumination passing through an objective lens and darkfield observation using laser oblique illumination (for example, Patent Documents 1 to 3).

### PRIOR ART DOCUMENT(S)

### Patent Document(s)

[Patent Document 1] JP2022-119894A
[Patent Document 2] JP2024-84208A
[Patent Document 3] JP2017-207522A
[Patent Document 4] JP3805735B2
[Patent Document 5] U.S. Pat. No. 7,180,658B2
[Patent Document 6] U.S. Pat. No. 8,675,276B2
[Patent Document 7] U.S. Pat. No. 7,502,177B2
[Patent Document 8] U.S. Pat. No. 6,560,039B1

### NON-PATENT DOCUMENT(S)

[Non-Patent Document 1] David R. Shafer et al., “Small catadioptric microscope optics,” Current Developments in Lens Design and Optical Engineering V, Proceedings of SPIE Vol. 5523
[Non-Patent Document 2] J. Webb et al., “Optical Design Forms for DUV&VUV Microlithographic Processes,” Optical Microlithography XIV, Proceedings of SPIE Vol. 4346

Incidentally, it is demanded to use a broadband incoherent light source for epi-illumination and to use laser for oblique illumination. To conduct such inspection, an objective lens is firstly required to operate over a broad spectral range, and also required to have long working distance so that laser oblique illumination can be delivered. Many objective lenses have been proposed (Patent Documents 4 to 8, Non-Patent Documents 1 to 2), but there is no report of one that possesses both a long working distance and good correction of chromatic aberration over a broad spectral range including deep ultraviolet (DUV) region.

One possible way to solve such problems is to prepare multiple objective lenses and switch between them for different wavebands. However, the increased complexity and increased cost of the entire system cannot be disregarded.

### SUMMARY OF THE INVENTION

In view of the foregoing background, an object of the present invention is to provide an objective lens that possesses both a long working distance and good correction of chromatic aberration over a broad spectral range including DUV region.

To achieve the above object, one aspect of the present invention provides a catadioptric objective lens that is infinity-corrected, the catadioptric objective lens comprising, in order from an infinite conjugate side: a first group (10, 110, 210) composed of at least one refractive optical element; a second group (20, 120, 220) composed of multiple optical elements including two reflective surfaces; and a third group (30,130, 230) composed of at least one optical element, wherein the catadioptric objective lens has an intermediate image point inside an optical system and satisfies a following conditional expression:

$$\frac{f 1}{f 3} < 0$$

where f1 is a focal length of the first group and f3 is a focal length of the third group.

According to this configuration, in the objective lens, chromatic aberration is well corrected over a broad spectral range.

In the above aspect, preferably, the first group satisfies a following conditional expression.

$$f 1 < 0$$

According to the above aspect, high numerical aperture (NA) is achieved as an additional advantage.

In the above aspect, preferably, the third group includes two reflective surfaces (M3, M4, MM23, MM24, MM31, MM32) and a refractive optical element (L6 to L9, L26 to L28, L34 to L38).

According to this configuration, a catadioptric objective lens having long working distance can be achieved.

In the above aspect, preferably, the refractive optical elements are all made of a single glass material.

According to this configuration, optical performance can be resistant to environmental temperature change.

According to the foregoing arrangement, an objective lens is achieved to have both the capability to operate over a broad spectral range (including DUV region) and the long working distance.

### BRIEF DESCRIPTION OF THE DRAWINGS

FIG. 1 is a conceptual diagram of a catadioptric optical system composed of three groups;

FIG. 2 is a diagram of a thin lens model including one ideal lens;

FIG. 3 is a diagram of a thin lens model including two ideal lenses;

FIG. 4 is a configuration diagram of a catadioptric objective lens of Embodiment 1;

FIG. 5 is a graph showing chromatic focus shift of the catadioptric objective lens of Embodiment 1;

FIG. 6 is a configuration diagram of a catadioptric objective lens of Embodiment 2;

FIG. 7 is a graph showing chromatic focus shift of the catadioptric objective lens of Embodiment 2;

FIG. 8 is a configuration diagram of a catadioptric objective lens of Embodiment 3; and

FIG. 9 is a graph showing chromatic focus shift of the catadioptric objective lens of Embodiment 3.

### DETAILED DESCRIPTION OF THE INVENTION

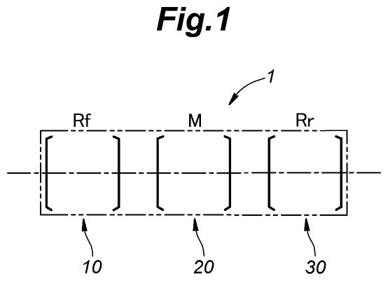

In the following, embodiments of a catadioptric objective lens according to the present invention will be described with reference to FIGS. 1 to 9.

First, the theory of axial chromatic aberration correction in the catadioptric objective lens (hereinafter may be abbreviated as the objective lens) according to the present invention is explained.

Referring to FIG. 1, shown is a figure illustrating an optical lens system (objective lens 1) composed of a first group 10 (front lens group), a second group 20 (intermediate group) and a third group 30 (rear lens group). These groups are assumed to be arranged on a common optical axis. Besides, the first group 10 and the third group 30 are both thin lens systems made of the same glass material. The optical power of the second group 20 does not depend on a wavelength λ.

In the following, conditions for correcting axial chromatic aberration in this lens system are discussed using a ray transfer matrix.

Suppose that a ray transfer matrix Rf of the first group 10 is expressed as:

$${R}_{f} = [ \begin{matrix}1 & 0 \\ - ϕ ( λ ) & 1\end{matrix} ]$$

where φ(λ) is optical power that is a function of a wavelength λ.

Then, a ray transfer matrix Rr of the third group 30 can be expressed as:

$${R}_{r} = [ \begin{matrix}1 & 0 \\ - γϕ ( λ ) & 1\end{matrix} ]$$

where γ is a real number representing the ratio between the power of the first group 10 and the power of the third group 30.

Further, suppose that a ray transfer matrix M of the second group 20 is expressed by

$$M = [ \begin{matrix}a & b \\ c & d\end{matrix} ] ,$$

then a ray transfer matrix A of the whole lens system is calculated as follows.

$$\begin{matrix}A = {R}_{r} {MR}_{f} \\ = [ \begin{matrix}1 & 0 \\ - γ ϕ ( λ ) & 1\end{matrix} ] [ \begin{matrix}a & b \\ c & d\end{matrix} ] [ \begin{matrix}1 & 0 \\ - ϕ ( λ ) & 1\end{matrix} ] \\ = [ \begin{matrix}- b ϕ ( λ ) + a & b \\ b γ ϕ {( λ )}^{2} - ( a γ + d ) ϕ ( λ ) + c & - b γ ϕ ( λ ) + d\end{matrix} ]\end{matrix}$$

For infinite conjugate, the initial ray vector is expressed by

$$[ \begin{matrix}{y}_{0} \\ {u}_{0}\end{matrix} ] = [ \begin{matrix}1 \\ 0\end{matrix} ] ,$$

then the last ray vector is calculated as follows.

$$\begin{matrix}[ \begin{matrix}{y}_{k}^{′} \\ {u}_{k}^{′}\end{matrix} ] = A [ \begin{matrix}1 \\ 0\end{matrix} ] \\ = [ \begin{matrix}- b ϕ ( λ ) + a \\ b γ ϕ {( λ )}^{2} - ( a γ + d ) ϕ ( λ ) + c\end{matrix} ]\end{matrix}$$

Therefore, a paraxial image distance L′ is calculated:

$$\begin{matrix}{L}^{′} = - \frac{{y}_{k}^{′}}{{u}_{k}^{′}} \\ = - \frac{- b ϕ ( λ ) + a}{b γ ϕ {( λ )}^{2} - ( a γ + d ) ϕ ( λ ) + c}\end{matrix}$$

Recalling here that the second group 20 is not a function of the wavelength λ, the only parameter that depends on the wavelength λ is φ(λ). Therefore, correction of the axial chromatic aberration requires that all the coefficient of φ(λ) is 0, namely, the following is required.

$$\begin{matrix}b = 0 \\ a γ + d = 0\end{matrix}$$

Further, the property of the ray transfer matrix gives the following formula.

$$\vert M \vert = ad - b c = 1$$

To sum up the foregoing, the conditions for correcting the axial chromatic aberration are:

$$\begin{matrix}M = [ \begin{matrix}a & 0 \\ c & \frac{1}{a}\end{matrix} ] \\ γ < 0 \\ {a}^{2} = - γ\end{matrix}$$

These formulas can be interpreted that the first group 10 and the third group 30 are arranged to be conjugate, and the second group 20 is configured to have a magnification determined by the ratio between the power of the first group 10 and the power of the third group 30.

Also, the formula γ<0 expresses that the power of the first group 10 and the power of the third group 30 have opposite signs. This formula can be also expressed by:

$$\frac{f 1}{f 3} < 0$$

where f1 is the focal length of the first group 10, and f3 is the focal length of the third group 30.

Next, specific system configuration is discussed using an “ideal lens” which performs a perfect thin lens that does not generate any aberration including chromatic aberration. Here, it should be paid attention that the solution satisfying the conditions for axial chromatic aberration correction is not uniquely determined. Thus, the design process starts with determining the number of components and then specific values will be applied.

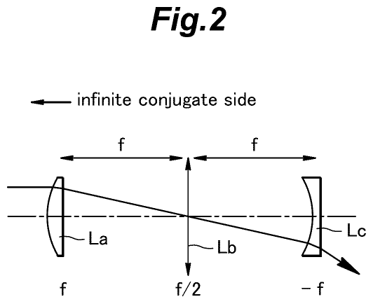

First, suppose that one ideal lens is used, a design solution as shown in FIG. 2 is obtained. As shown in FIG. 2, this system is composed of a positive thin lens La, an ideal lens Lb, and a negative thin lens Le arranged in this order from the infinite conjugate side. This can be interpreted as augmented Schupmann lens with its field lens replaced by an ideal lens.

However, this system is unsuitable for a long working distance design, since the final image is formed inside of the system.

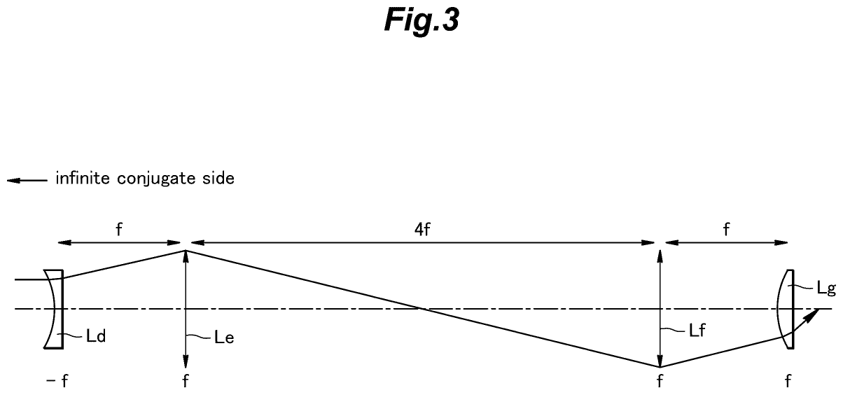

Therefore, one more ideal lens is needed to ensure a degree of freedom as shown in FIG. 3. This system includes, in order from the infinite conjugate side, a negative thin lens Ld, a first ideal lens Le, a second ideal lens Lf, and a positive thin lens Lg. An intermediate image is formed inside the system, while the final image is formed outside.

Namely, the following formula is satisfied.

$$f 1 < 0$$

where f1 is the focal length of the first group 10.

This formula gives the configuration that the first group has negative power, and the third group has positive power, which is advantageous for obtaining both high NA and a long working distance.

As a final step, the ideal lenses are replaced with reflective elements (mirrors), recalling mirrors generate no chromatic aberration. This operation gives a practical paraxial configuration of a catadioptric objective lens which possesses good correction of chromatic aberration and a long working distance.

An optical system is somehow optimized to a given requirement. So, the actual designs need not be in a strict numerical agreement with the formulas disclosed in this document.

The objective lens 1 of the present embodiment is, in summary, an infinity-corrected catadioptric objective lens and includes, in order from the infinite conjugate side, the first group 10, the second group 20, and the third group 30. The first group 10 is composed of at least one refractive optical element (for example, the negative thin lens Ld in FIG. 3). The second group 20 includes two reflective surfaces that are disposed to face each other and realize the ideal lenses Le, Lf of the optical system shown in FIG. 3. The third group 30 is composed of at least one optical element (for example, the positive thin lens Lg in FIG. 3). The objective lens 1 has an intermediate image point inside the optical system, and satisfies the following conditional expression (theoretical formula).

$$\frac{f 1}{f 3} < 0$$

where f1 is the focal length of the first group 10, and f3 is the focal length of the third group 30.

In this objective lens 1, chromatic aberration is well corrected over a wide wavelength range.

In addition, the first group 10 satisfies the following condition.

$$f 1 < 0$$

In this objective lens 1, high NA is achieved as an additional advantage.

As the premise of the above theory, the refractive optical elements used in the catadioptric objective lens are all made of a single glass material. This configuration, moreover, enables to match the coefficient of thermal expansion of glasses and that of mechanical parts, which result in an advantageous feature that the optical performance is resistant to environmental temperature change. Also preferably, configuration should be made such that two reflective surfaces are included in the third group 30. Thereby, the final image point can be positioned outside the optical system, and a long working distance is achieved.

Based on the above considerations, significance of the present invention compared to the prior art is explained below.

Patent Document 4 discloses an all-refractive objective lens that can operate over a bandwidth of approximately +5 nm in the DUV region. However, the disclosed objective lenses are not capable of extending correction range of chromatic aberration to a broader spectral range including the visible region.

Patent Documents 5 and 6 and Non-Patent Document 1 disclose catadioptric optical systems in which chromatic aberration is corrected over a broad spectral range. The objective lenses described in these documents have been developed from an arrangement called Schupmann type. As mentioned above, the present disclosure theoretically points out that Schupmann lens is considered one particular solution favorably correcting axial chromatic aberration, and it is not suitable for a long working distance design. Actually, the Patent Documents only disclose optical systems with a working distance of at most 1 mm or less. Further, it is worth noting that the large diameter of optical elements near the image plane possibly interrupts oblique laser illumination.

Patent Document 7 discloses an optical system with increased number of reflective surfaces while partially applying the optical system of Patent Document 3. However, the optical system described in Patent Document 7 cannot achieve chromatic aberration correction over a broader spectral range from the DUV region to the visible region. This is because the theoretical formulas mentioned above in the present disclosure as the conditions for correcting the axial chromatic aberration are not satisfied.

Patent Document 8 and Non-Patent Document 2 disclose catadioptric objective lenses developed from the Schwarzschild type. Also, these documents point out that the catadioptric optical system is advantageous in chromatic aberration correction compared to the all-refractive optical system. However, in these catadioptric objective lenses, chromatic aberration is corrected only in a bandwidth of approximately 10 nm, and the bandwidth cannot be extended to a broader range.

The objective lens 1 of the present embodiment is a new lens type which achieves both chromatic aberration correction over a broad spectral range (from the DUV region to the visible region) and a long working distance. The theoretical description of the present document exhibits technical significance which depicts the clear difference from the conventional catadioptric objective lenses, and further, contributes to a variety of catadioptric optical system designs.

### Embodiment 1

The lens data of Embodiment 1 is shown in Table 1. The numerical values for conditional expressions of Embodiment 1 are shown in Table 2. In the catadioptric objective lens shown in Embodiment 1, the wavelength λ=266 nm to 900 nm, the focal length=−2.0 mm, and NA=0.85.

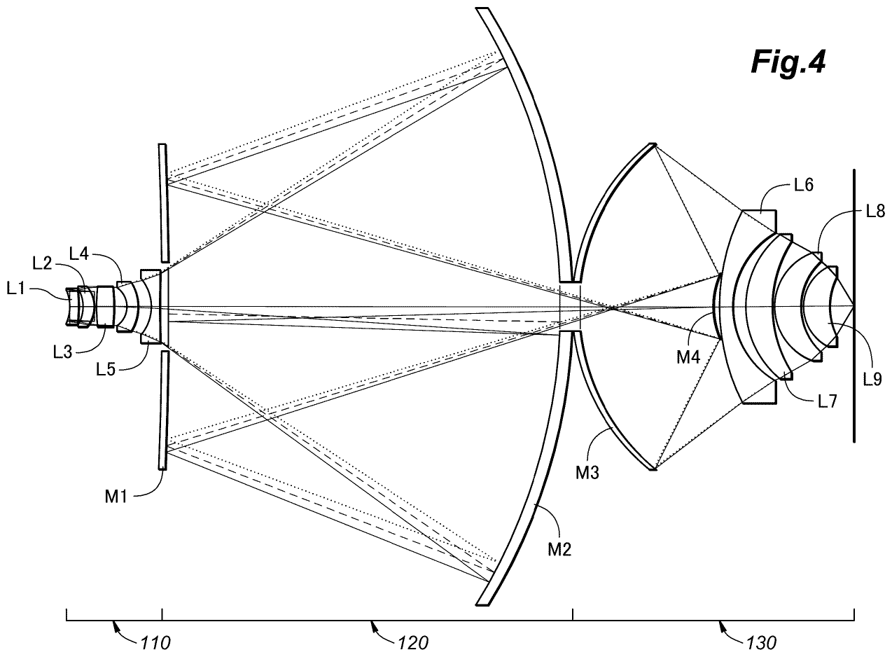

As shown in FIG. 4, the catadioptric objective lens of Embodiment 1 includes, in order from the infinite conjugate side, a first group 110 having a negative power, a second group 120 having a positive power, and a third group 130 having a positive power. The catadioptric objective lens of Embodiment 1 has an intermediate image point inside the optical system (the third group 130).

The first group 110 is composed of five refractive optical elements L1 to L5. The second group 120 is composed of two mirrors M1 (reflective surface) and M2 (reflective surface). The third group 130 is composed of two mirrors M3 (reflective surface) and M4 (reflective surface) and four refractive optical elements L6 to L9.

The refractive optical elements L1 to L9 included in the catadioptric objective lens of Embodiment 1 are all made of Silica.

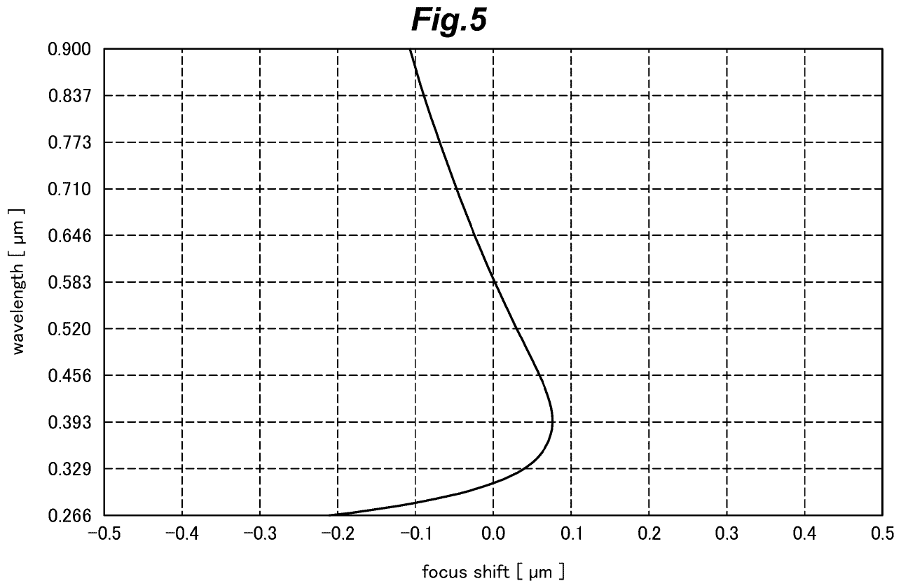

FIG. 5 shows chromatic focus shift plot (wavelength-focus shift performance) of the catadioptric objective lens of Embodiment 1.

TABLE 1

| Surface | Radius | Thickness | |
|---|---|---|---|
| Number | (mm) | (mm) | Glass |
| Obj | Infinity | Infinity | — |
| 1 | Infinity | 2.8162 | |
| 2 | Infinity | −2.8162 | |
| 3 | −4.7093 | 1.0000 | Silica |
| 4 | −21.8659 | 0.5000 | |
| 5 | −4.0552 | 1.2500 | Silica |
| 6 | −3.5915 | 0.3000 | |
| 7 | 22.6886 | 2.0000 | Silica |
| 8 | −22.0537 | 1.5000 | |
| 9 | −2.6810 | 1.2500 | Silica |
| 10 | −5.3725 | 1.5000 | |
| 11 | −5.0000 | 1.0000 | Silica |
| 12 | 188.3262 | 45.9326 | |
| 13 | −65.1573 | −44.9326 | Mirror |
| 14 | −464.8665 | 45.8710 | Mirror |
| 15 | Infinity | 16.5059 | |
| 16 | 9.2026 | −15.3777 | Mirror |
| 17 | 24.0983 | 15.3777 | Mirror |
| 18 | Infinity | 0.7500 | |
| 19 | 24.3753 | 1.5000 | Silica |
| 20 | 9.8029 | 1.5000 | |
| 21 | 10.6669 | 3.0000 | Silica |
| 22 | 13.7748 | 0.3000 | |
| 23 | 6.5560 | 3.0000 | Silica |
| 24 | 6.9939 | 0.3000 | |
| 25 | 5.1001 | 3.0000 | Silica |
| 26 | 7.4942 | 2.8365 | |
| Img | Infinity | — | — |

TABLE 2

| | |
|---|---|
| f1 | −4.41 |
| f3 | 32.98 |
| f1/f3 | −0.13 |

### Embodiment 2

The lens data of Embodiment 2 is shown in Table 3. The numerical values for conditional expressions of Embodiment 2 are shown in Table 4. In the catadioptric objective lens shown in Embodiment 2, the wavelength 2=193 nm to 1100 nm, the focal length=−4.0 mm, and NA=0.85.

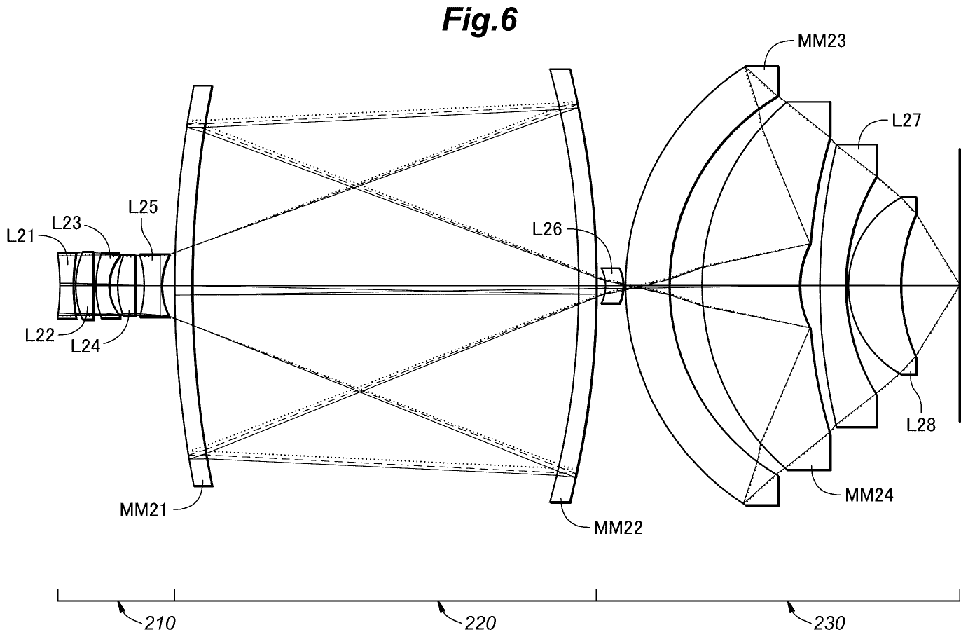

As shown in FIG. 6, the catadioptric objective lens of Embodiment 2 includes, in order from the infinite conjugate side, a first group 210 having a negative power, a second group 220 having a positive power, and a third group 230 having a positive power. Similarly to Embodiment 1, the catadioptric objective lens of Embodiment 2 also has an intermediate image point inside the optical system.

The first group 210 is composed of five refractive optical elements L21 to L25. The second group 220 is composed of two meniscus lenses with mirrored surfaces (may be also called Mangin mirrors) MM21 (reflective surface) and MM22 (reflective surface). The third group 230 is composed of two meniscus lenses with mirrored surfaces MM23 (reflective surface) and MM24 (reflective surface) and three refractive optical elements L26 to L28. The surface of MM24 on the image plane side has a complicated profile, and the radius of curvature of the outer area is different from that of the central area. The central area has a reflection property.

The refractive optical elements L21 to L28 included in the catadioptric objective lens of Embodiment 2 are all made of CaF₂. Also, meniscus lenses with mirrored surfaces MM21 to MM24 are all made of CaF₂.

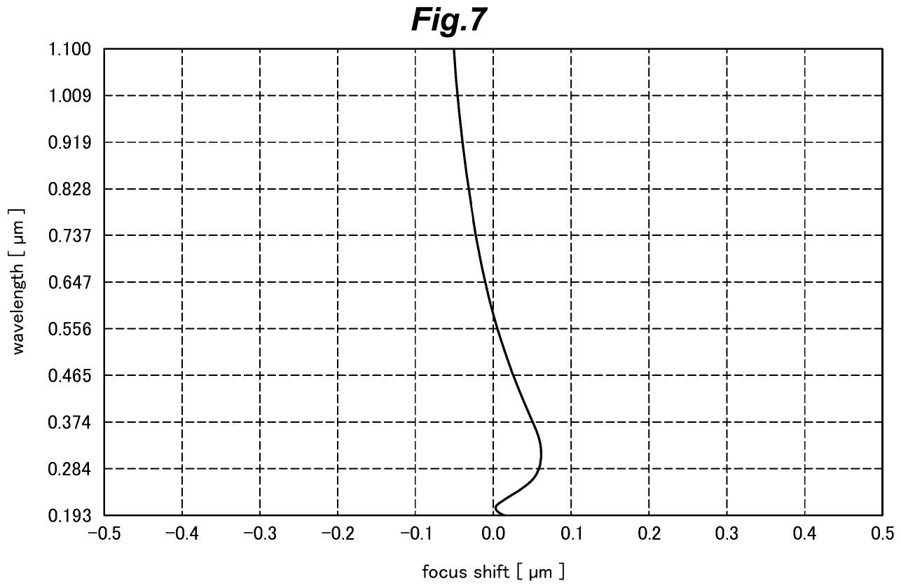

FIG. 7 shows chromatic focus shift plot (wavelength-focus shift performance) of the catadioptric objective lens of Embodiment 2.

TABLE 3

| Surface | Radius | Thickness | |
|---|---|---|---|
| Number | (mm) | (mm) | Glass |
| Obj | Infinity | Infinity | — |
| 1 | Infinity | 11.4599 | |
| 2 | Infinity | −11.4599 | |
| 3 | −27.3275 | 1.5000 | CaF₂ |
| 4 | 21.7583 | 0.3000 | |
| 5 | 9.7980 | 2.0000 | CaF₂ |
| 6 | 166.5108 | 0.3000 | |
| 7 | 11.0026 | 1.5000 | CaF₂ |
| 8 | 5.3258 | 1.0000 | |
| 9 | 9.4444 | 2.0000 | CaF₂ |
| 10 | −297.1140 | 1.0000 | |
| 11 | −12.9923 | 2.0000 | CaF₂ |
| 12 | 7.5526 | 3.5000 | |
| 13 | Infinity | 44.2298 | |
| 14 | −93.4493 | 2.0000 | CaF₂ |
| 15 | −100.7920 | −2.0000 | Mirror |
| 16 | −93.4493 | −44.2298 | |
| 17 | 117.0665 | −2.0000 | CaF₂ |
| 18 | 119.3819 | 2.0000 | Mirror |
| 19 | 117.0665 | 44.2298 | |
| 20 | Infinity | 3.0000 | |
| 21 | −4.5866 | 2.0000 | CaF₂ |
| 22 | −4.8592 | 0.3000 | |
| 23 | 29.7879 | 5.0000 | CaF₂ |
| 24 | 25.1555 | 3.7361 | |
| 25 | 27.5887 | 11.1545 | CaF₂ |
| 26 | 10.3315 | −11.1545 | Mirror |
| 27 | 27.5887 | −3.7361 | |
| 28 | 25.1555 | −5.0000 | CaF₂ |
| 29 | 29.7879 | 5.0000 | Mirror |
| 30 | 25.1555 | 3.7361 | |
| 31 | 27.5887 | 11.1545 | CaF₂ |
| 32 | Infinity | 1.0000 | CaF₂ |
| 33 | 59.6630 | 1.2952 | |
| 34 | 68.9668 | 2.9583 | CaF₂ |
| 35 | 23.8908 | 0.3000 | |
| 36 | 11.4319 | 6.0000 | CaF₂ |
| 37 | 20.2442 | 6.7534 | |
| Img | Infinity | — | — |

TABLE 4

| | |
|---|---|
| f1 | −13.63 |
| f3 | 6.46 |
| f1/f3 | −2.11 |

### Embodiment 3

The lens data of Embodiment 3 is shown in Table 5. The numerical values for conditional expressions of Embodiment 3 are shown in Table 6. In the catadioptric objective lens shown in Embodiment 3, the wavelength Δ=266 nm to 900 nm, the focal length=−10.0 mm, and NA=0.5. Note that in the lens data of Table 5, the lens surfaces 22, 32 marked with asterisk (*) are aspheric surfaces. Coefficient values defining the aspheric surface shapes of the lens surfaces 22, 32 marked with asterisk (*) in the lens data are shown in Table 7.

The shape of the aspheric surface is defined such that, provided that the displacement in a direction perpendicular to the optical axis is denoted by y, the displacement from the intersection of the aspheric surface and the optical axis in the optical axis direction is denoted by z, the conic coefficient is denoted by K, and the fourth-order, sixth-order, eighth-order, tenth-order, and twelfth-order aspheric surface coefficients are respectively denoted by A4, A6, A8, A10, and A12, the coordinate on the aspheric surface is represented by the following formula.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12}$$

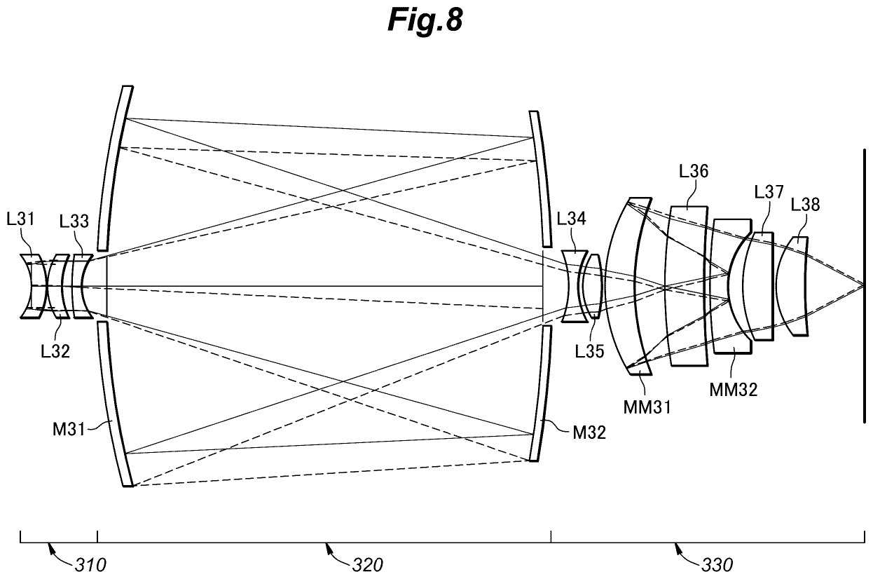

As shown in FIG. 8, the catadioptric objective lens of Embodiment 3 includes, in order from the infinite conjugate side, a first group 310 having a negative power, a second group 320 having a positive power, and a third group 330 having a positive power. Similarly to Embodiment 1, the catadioptric objective lens of Embodiment 3 also has an intermediate image point inside the optical system.

The first group 310 is composed of three refractive optical elements L31 to L33. The second group 320 is composed of two mirrors M31 (reflective surface) and M32 (reflective surface). The third group 330 is composed of two meniscus lenses with mirrored surfaces MM31 (reflective surface) and MM32 (reflective surface) and five refractive optical elements L34 to L38. On the image plane side of MM32, the central area forms a reflective surface and the outer area forms a refractive surface.

The refractive optical elements L31 to L38 included in the catadioptric objective lens of Embodiment 3 are all made of Silica. Also, the meniscus lenses with mirrored surfaces MM31 to MM32 are all made of Silica.

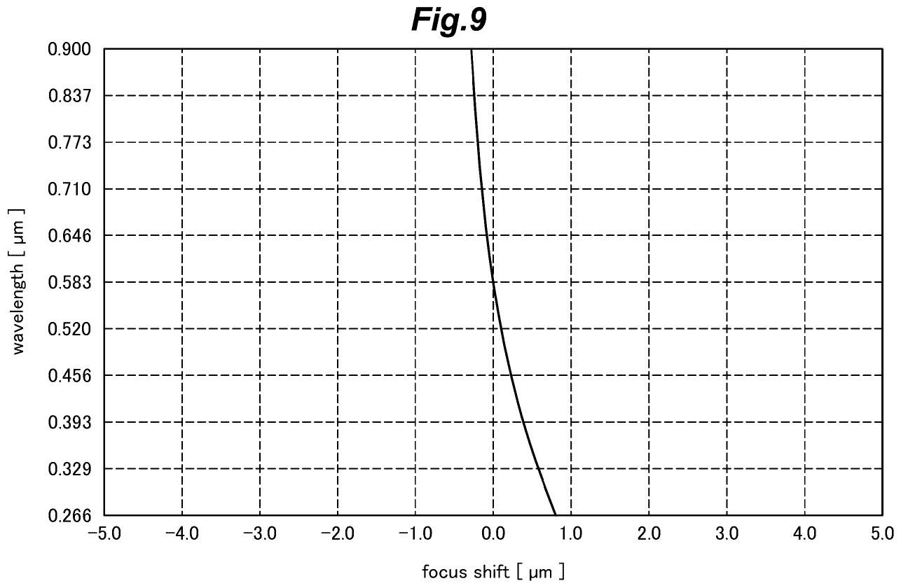

FIG. 9 shows axial chromatic focus shift plot (wavelength-focus shift performance) of the catadioptric objective lens of Embodiment 3.

TABLE 5

| Surface | Radius | Thickness | |
|---|---|---|---|
| Number | (mm) | (mm) | Glass |
| Obj | Infinity | Infinity | |
| 1 | Infinity | 4.7800 | |
| 2 | Infinity | −4.7800 | |
| 3 | −12.0177 | 3.0000 | Silica |
| 4 | −21.0942 | 0.3000 | |
| 5 | 15.4332 | 3.0000 | Silica |
| 6 | 18.2576 | 2.0000 | |
| 7 | 56.7185 | 2.0000 | Silica |
| 8 | 11.6838 | 5.0000 | |
| 9 | Infinity | 89.6346 | |
| 10 | −275.2987 | −89.6346 | Mirror |
| 11 | 189.2558 | 89.6346 | Mirror |
| 12 | Infinity | 5.0000 | |
| 13 | −24.3282 | 2.0000 | Silica |
| 14 | 14.5225 | 1.0000 | |
| 15 | 15.2583 | 4.0000 | Silica |
| 16 | −25.5713 | 0.5000 | |
| 17 | 40.5900 | 6.0000 | Silica |
| 18 | 61.8346 | 6.1994 | |
| 19 | 133.6574 | 8.0000 | Silica |
| 20 | 242.7778 | 1.0000 | |
| 21 | 103.0297 | 4.0000 | Silica |
| 22* | 18.3286 | −4.0000 | Mirror |
| 23 | 103.0297 | −1.0000 | |
| 24 | 242.7778 | −8.0000 | Silica |
| 25 | 133.6574 | −6.1994 | |
| 26 | 61.8346 | −6.0000 | Silica |
| 27 | 40.5900 | 6.0000 | Mirror |
| 28 | 61.8346 | 6.1994 | |
| 29 | 133.6574 | 8.0000 | Silica |
| 30 | 242.7778 | 1.0000 | |
| 31 | 103.0297 | 4.0000 | Silica |
| 32* | 18.3286 | 3.0000 | |
| 33 | 32.8588 | 6.0000 | Silica |
| 34 | 5051.4400 | 0.6000 | |
| 35 | 18.8810 | 6.0000 | Silica |
| 36 | 120.0731 | 12.3583 | |
| Img | Infinity | — | |

TABLE 6

| | |
|---|---|
| f1 | −23.8 |
| f3 | 9.66 |
| f1/f3 | −2.46 |

TABLE 7

| | |
|---|---|
| k | 0 |
| A4 | −4.96370E−07 |
| A6 | −5.41510E−09 |
| A8 | −1.48770E−11 |

In the foregoing, the present invention has been described in terms of preferred embodiments thereof, but as will be appreciated easily by a person of ordinary skill in the art, the present invention is not limited by such embodiments, and various modifications may be made as appropriate without departing from the spirit of the present invention. Also, not all of the components shown in the above embodiments are necessarily indispensable, and they may be selectively adopted as appropriate without departing from the spirit of the present invention.

1. A catadioptric objective lens that is infinity-corrected, the catadioptric objective lens comprising, in order from an infinite conjugate side:
a first group composed of at least one refractive optical element;
a second group composed of multiple optical elements including two reflective surfaces; and
a third group composed of at least one optical element,
wherein the catadioptric objective lens has an intermediate image point inside an optical system and satisfies a below conditional expression:
$$\frac{f 1}{f 3} < 0$$
where f1 is a focal length of the first group and f3 is a focal length of the third group.

2. The catadioptric objective lens according to claim 1, wherein the first group satisfies a below conditional expression.
$$f 1 < 0$$

3. The catadioptric objective lens according to claim 2, wherein the third group includes two reflective surfaces.

4. The catadioptric objective lens according to claim 1, wherein the refractive optical elements included in the catadioptric objective lens are all made of a single glass material.
